(19) United States
(12) Patent Application Publication
(10) Pub. No.: US 2017/0116154 A1
(43) Pub. Date: Apr. 27, 2017

(54) REGISTER COMMUNICATION IN A NETWORK-ON-A-CHIP ARCHITECTURE

(71) Applicant: The Intellisis Corporation, San Diego, CA (US)

(72) Inventors: Douglas A. Palmer, San Diego, CA (US); Andrew White, Austin, TX (US)

(73) Assignee: THE INTELLISIS CORPORATION, San Diego, CA (US)

(21) Appl. No.: 14/921,377

(22) Filed: Oct. 23, 2015

(51) Int. Cl. G06F 15/82; G06F 9/30

(52) U.S. Cl. CPC G06F 15/82; G06F 9/30098

(57) ABSTRACT

A network on a chip processor uses uniform addressing for both conventional memory and operand registers. The processor contains a large number of processing elements (e.g., 256). Each processing element has a number (e.g., 200) of operand registers to which it has direct, high-speed (e.g., single clock-cycle) access. Each of these operand registers is also assigned a global memory address, so other processing elements can read or write those operand registers as if they were located in main memory. Software that expects communication between processing elements to happen via memory can use memory-based reads/writes, but gain substantial speed by writing that data directly to the operand registers used for execution of instructions by the target processor.

### BACKGROUND

Multi-processor computer architectures capable of parallel computing operations were originally developed for supercomputers. Today, with modern microprocessors containing multiple processor “cores,” the principles of parallel computing have become relevant to both on-chip and distributed computing environment.

### BRIEF DESCRIPTION OF DRAWINGS

For a more complete understanding of the present disclosure, reference is now made to the following description taken in conjunction with the accompanying drawings.

FIG. 1 is a block diagram conceptually illustrating an example of a network-on-a-chip architecture that supports inter-element register communication.

FIG. 2 is a block diagram conceptually illustrating example components of a processing element of the architecture in FIG. 1.

FIG. 3 illustrates an example of instruction execution by the processor core in FIG. 2.

FIG. 4 illustrates an example of a flow of the pipeline stages of the processor core in FIG. 2.

FIG. 5 illustrates an example of a packet header used to support inter-element register communication.

FIG. 6A illustrates an example of a configuration of the operand registers from FIG. 2, including a banks of registers arranged as a mailbox queue to receive data via write transactions.

FIG. 6B is an abstract representation of how the banks of registers are accessed and recycled within the circular mailbox queue.

FIGS. 7A to 7F illustrate write and read transaction operations of the queue from FIG. 6A.

FIG. 8 is an schematic overview illustrating an example of circuitry that directs write and read transaction operations to sets of the operand registers serving as the banks of the mailbox queue.

FIG. 9 is another schematic overview illustrating an example of circuitry that directs write and read transaction operations to sets of the operand registers serving as the banks of the mailbox queue.

### DETAILED DESCRIPTION

One widely used method for communication between processors in conventional parallel processing systems is for one processing element (e.g., a processor core and associated peripheral components) to write data to a location in a shared general-purpose memory, and another processing element to read that data from that memory. In such systems, processing elements typically have little or no direct communication with each other. Instead, processes exchange data by having a source processor store the data in a shared memory, and having the target processor copy the data from the shared memory into its own internal registers for processing.

This method is simple and straightforward to implement in software, but suffers from substantial overhead. Memory reads and writes require substantial time and power to execute. Furthermore, general-purpose main memory is usually optimized for maximum bandwidth when reading/writing large amounts of data in a stream. When only a small amount of data needs to be written to memory, transmitting data to memory carries relatively high latency. Also, due to network overhead, such small transactions may disproportionally reduce available bandwidth.

In parallel processing systems that may be scaled to include hundreds (or more) of processor cores, what is needed is a method for software running on one processing element to communicate data directly to software running on another processing element, while continuing to follow established programming models, so that (for example) in a typical programming language, the data transmission appears to take place as a simple assignment.

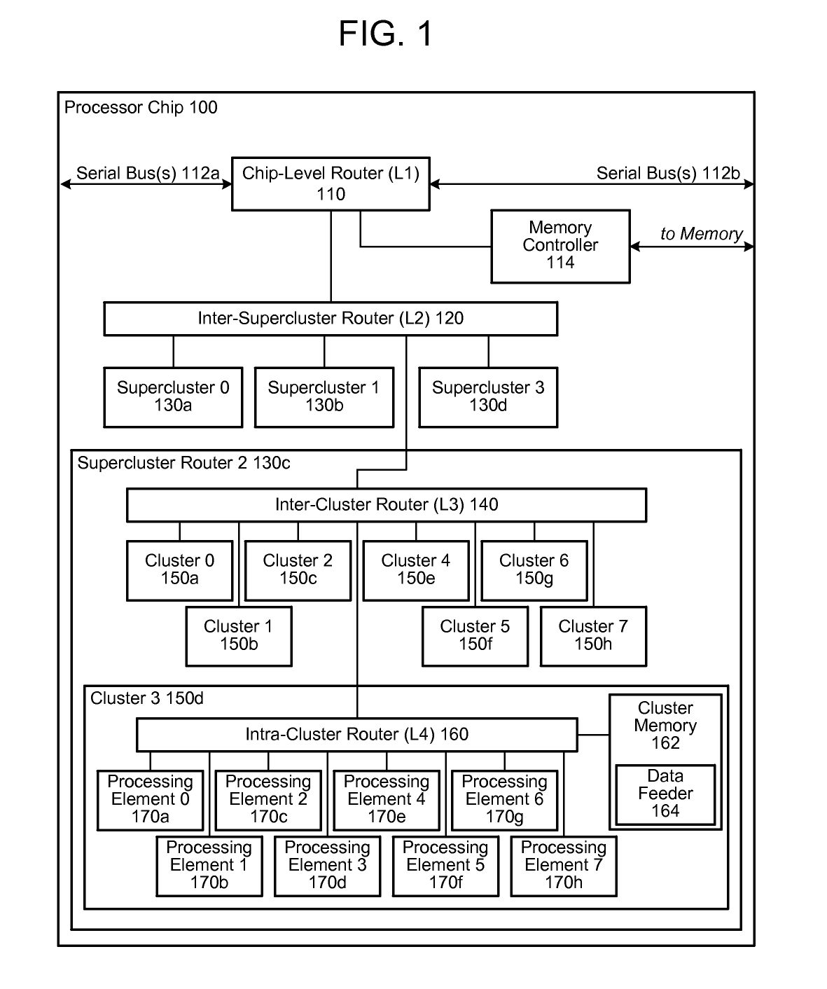

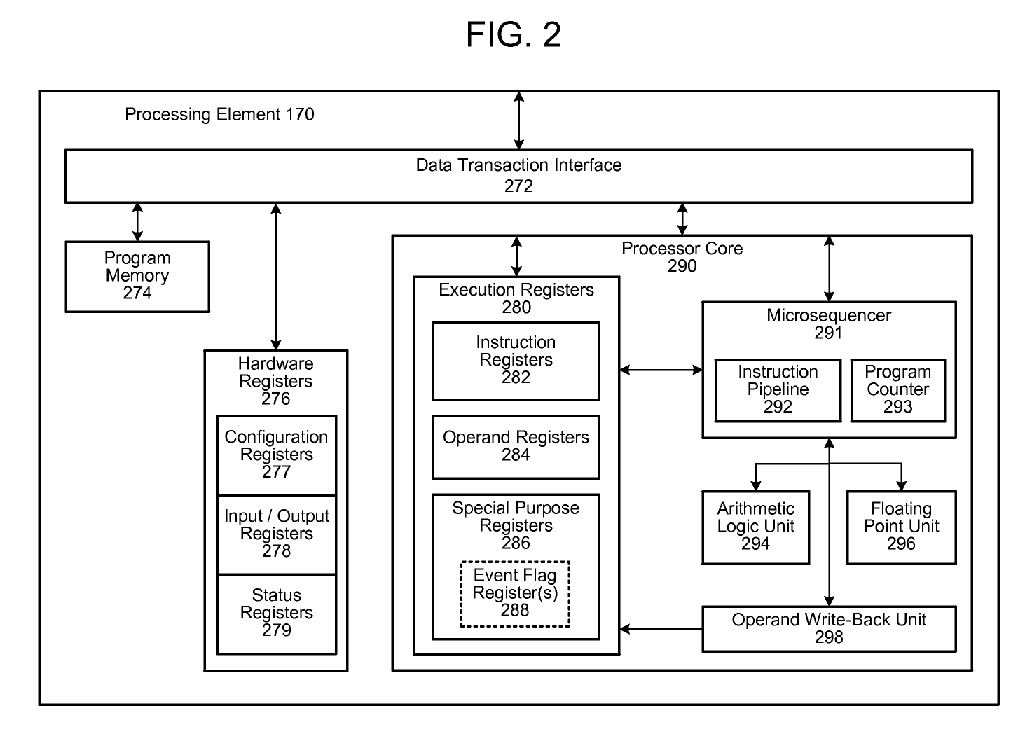

FIG. 1 is a block diagram conceptually illustrating an example of a network-on-a-chip architecture that supports inter-element register communication. A processor chip 100 may be composed of a large number of processing elements 170 (e.g., 256), connected together on the chip via a switched or routed fabric similar to what is typically seen in a computer network. FIG. 2 is a block diagram conceptually illustrating example components of a processing element 170 of the architecture in FIG. 1.

Each processing element 170 has direct access to some (or all) of the operand registers 284 of the other processing elements, such that each processing element 170 may read and write data directly into operand registers 284 used by instructions executed by the other processing element, thus allowing the processor core 290 of one processing element to directly manipulate the operands used by another processor core for opcode execution.

An “opcode” instruction is a machine language instruction that specifies an operation to be performed by the executing processor core 290. Besides the opcode itself, the instruction may specify the data to be processed in the form of operands. An address identifier of a register from which an operand is to be retrieved may be directly encoded as a fixed location associated with an instruction as defined in the instruction set (i.e. an instruction permanently mapped to a particular operand register), or may be a variable address location specified together with the instruction.

Each operand register 284 may be assigned a global memory address comprising an identifier of its associated processing element 170 and an identifier of the individual operand register 284. The originating processing element 170 of the read/write transaction does not need to take special actions or use a special protocol to read/write to another processing element's operand register, but rather may access another processing element's registers as it would any other memory location that is external to the originating processing element. Likewise, the processing core 290 of a processing element 170 that contains a register that is being read by or written to by another processing element does not need to take any action during the transaction between the operand register and the other processing element.

Conventional processing elements commonly include two types of registers: those that are both internally and externally accessible, and those that are only internally accessible. The hardware registers 276 in FIG. 2 illustrate examples of conventional registers that are accessible both inside and outside the processing element, such as configuration registers 277 used when initially “booting” the processing element, input/output registers 278, and various status registers 279. Each of these hardware registers are globally mapped, and are accessed by the processor core associated with the hardware registers by executing load or store instructions.

The internally accessible registers in conventional processing elements include instruction registers and operand registers, which are internal to the processor core itself. These registers are ordinarily for the exclusive use of the core for the execution of operations, with the instruction registers storing the instructions currently being executed, and the operand registers storing data fetched from hardware registers 276 or other memory as needed for the currently executed instructions. These internally accessible registers are directly connected to components of the instruction execution pipeline (e.g., an instruction decode component, an operand fetch component, an instruction execution component, etc.), such that there is no reason to assign them global addresses. Moreover, since these registers are used exclusively by the processor core, they are single “ported,” since data access is exclusive to the pipeline.

In comparison, the execution registers 280 of the processor core 290 in FIG. 2 may each be dual-ported, with one port directly connected to the core's micro-sequencer 291, and the other port connected to a data transaction interface 272 of the processing element 170, via which the operand registers 284 can be accessed using global addressing. As dual-ported registers, data may be read from a register twice within a same clock cycle (e.g., once by the micro-sequencer 291, and once by the data transaction interface 272).

As will be described further below, communication between processing elements 170 may be performed using packets, with each data transaction interface 272 connected to one or more busses, where each bus comprises at least one data line. Each packet may include a target register's address (i.e., the address of the recipient) and a data payload. The busses may be arranged into a network, such as the hierarchical network of busses illustrated in FIG. 1. The target register's address may be a global hierarchical address, such as identifying a multicore chip 100 among a plurality of interconnected multicore chips, a supercluster 130 of core clusters 150 on the chip, a core cluster 150 containing the target processing element 170, and a unique identifier of the individual operand register 284 within the target processing element 170.

For example, referring to FIG. 1, each chip 100 includes four superclusters 130a-130d, each supercluster 130 comprises eight clusters 150a-150h, and each cluster 150 comprises eight processing elements 170a-170h. If each processing element 170 includes two-hundred-fifty six operand registers 284, then within the chip 100, each of the operand registers may be individually addressed with a sixteen bit address: two bits to identify the supercluster, three bits to identify the cluster, three bits to identify the processing element, and eight bits to identify the register. The global address may include additional bits, such as bits to identify the processor chip 100, such that processing elements 170 may directly access the registers of processing elements across chips. The global addresses may also accommodate the physical and/or virtual addresses of a main memory accessible by all of the processing elements 170 of a chip 100, tiered memory locally shared by the processing elements 170 (e.g., cluster memory 162), etc. Whereas components external to a processing element 170 addresses the registers 284 of another processing element using global addressing, the processor core 290 containing the operand registers 284 may instead uses the register's individual identifier (e.g., eight bits identifying the two-hundred-fifty-six registers).

Other addressing schemes may also be used, and different addressing hierarchies may be used. Whereas a processor core 290 may directly access its own execution registers 280 using address lines and data lines, communications between processing elements through the data transaction interfaces 272 may be via a variety of different bus architectures. For example, communication between processing elements and other addressable components may be via a shared parallel bus-based network (e.g., busses comprising address lines and data lines, conveying addresses via the address lines and data via the data lines). As another example, communication between processing elements and other components may be via one or more shared serial busses.

Addressing between addressable elements/components may be packet-based, message-switched (e.g., a store-and-forward network without packets), circuit-switched (e.g., using matrix switches to establish a direct communications channel/circuit between communicating elements/components), direct (i.e., end-to-end communications without switching), or a combination thereof. In comparison, to message-switched, circuit-switched, and direct addressing, a packet-based conveys a destination address in a packet header and a data payload in a packet body via the data line(s).

As an example of an architecture using more than one bus type and more than one protocol, inter-cluster communications may be packet-based via serial busses, whereas intra-cluster communications may be message-switched or circuit-switched using parallel busses between the intra-cluster router (L4) 160, the processing elements 170a to 170h within the cluster, and other intra-cluster components (e.g., cluster memory 162). In addition, within a cluster, processing elements 170a to 170h may be interconnected to shared resources within the cluster (e.g., cluster memory 162) via a shared bus or multiple processing-element-specific and/or shared-resource-specific busses using direct addressing (not illustrated).

The source of a packet is not limited only to a processor core 290 manipulating the operand registers 284 associated with another processor core 290, but may be any operational element, such as a memory controller 114, a data feeder 164 (discussed further below), an external host processor connected to the chip 100, a field programmable gate array, or any other element communicably connected to a processor chip 100 that is able to communicate in the packet format.

A data feeder 164 may execute programmed instructions which control where and when data is pushed to the individual processing elements 170. The data feeder 164 may also be used to push executable instructions to the program memory 274 of a processing element 170 for execution by that processing element's instruction pipeline.

In addition to any operational element being able to write directly to an operand register 284 of a processing element 170, each operational element may also read directly from an operand register 284 of a processing element 170, such as by sending a read transaction packet indicating the global address of the target register to be read, and the global address of the destination address to which the reply including the target register's contents is to be copied.

A data transaction interface 272 associated with each processing element may execute such read, write, and reply operations without necessitating action by the processor core 290 associated with an accessed register. Thus, if the destination address for a read transaction is an operand register 284 of the processing element 170 initiating the transaction, the reply may be placed in the destination register without further action by the processor core 290 initiating the read request. Three-way read transactions may also be undertaken, with a first processing element 170x initiating a read transaction of a register located in a second processing element 170y, with the destination address for the reply being a register located in a third processing element 170z.

Memory within a system including the processor chip 100 may also be hierarchical. Each processing element 170 may have a local program memory 274 containing instructions that will be fetched by the micro-sequencer 291 in accordance with a program counter 293. Processing elements 170 within a cluster 150 may also share a cluster memory 162, such as a shared memory serving a cluster 150 including eight processor cores 290. While a processor core 290 may experience no latency (or a latency of one-or-two cycles of the clock controlling timing of the instruction pipeline 292) when accessing its own execution registers 280, accessing global addresses external to a processing element 170 may experience a larger latency due to (among other things) the physical distance between processing elements 170. As a result of this additional latency, the time needed for a processor core to access an external main memory, a shared cluster memory 162, and the registers of other processing elements may be greater than the time needed for a core 290 to access its own program memory 274 and execution registers 280.

Data transactions external to a processing element 170 may be implemented with a packet-based protocol carried over a router-based or switch-based on-chip network. The chip 100 in FIG. 1 illustrates a router-based example. Each tier in the architecture hierarchy may include a router. For example, in the top tier, a chip-level router (L1) 110 routes packets between chips via one or more high-speed serial busses 112a, 112b, routes packets to-and-from a memory controller 114 that manages primary general-purpose memory for the chip, and routes packets to-and-from lower tier routers.

The superclusters 130a-130d may be interconnected via an inter-supercluster router (L2) 120 which routes transactions between superclusters and between a supercluster and the chip-level router (L1) 110. Each supercluster 130 may include an inter-cluster router (L3) 140 which routes transactions between each cluster 150 in the supercluster 130, and between a cluster 150 and the inter-supercluster router (L2). Each cluster 150 may include an intra-cluster router (L4) 160 which routes transactions between each processing element 170 in the cluster 150, and between a processing element 170 and the inter-cluster router (L3). The level 4 (L4) intra-cluster router 160 may also direct packets between processing elements 170 of the cluster and a cluster memory 162. Tiers may also include cross-connects (not illustrated) to route packets between elements in a same tier in the hierarchy. A processor core 290 may directly access its own operand registers 284 without use of a global address.

Memory of different tiers may be physically different types of memory. Operand registers 284 may be a faster type of memory in a computing system, whereas as external general-purpose memory typically may have a higher latency. To improve the speed with which transactions are performed, operand instructions may be pre-fetched from slower memory and stored in a faster program memory (e.g., program memory 274 in FIG. 2) prior to the processor core 290 needing the operand instruction.

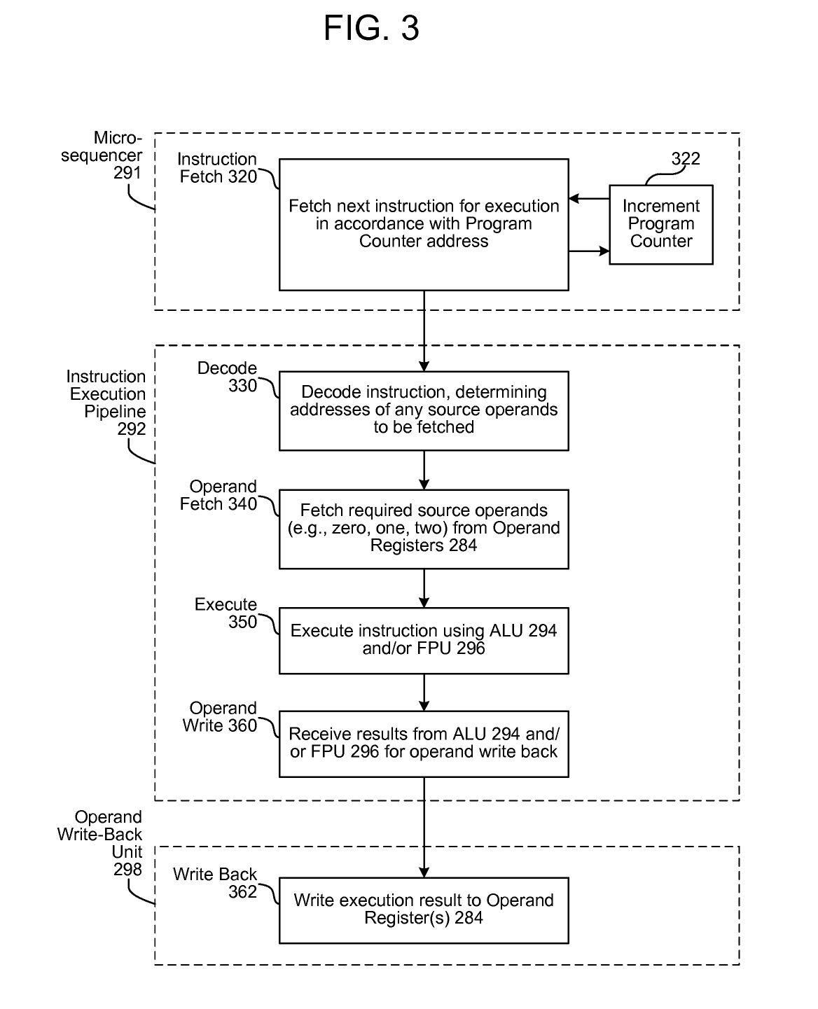

Referring to FIGS. 2 and 3, a micro-sequencer 291 of the processor core 290 may fetch (320) a stream of instructions for execution by the instruction execution pipeline 292 in accordance with a memory address specified by a program counter 293. The memory address may be a local address corresponding to an address in the processing element's own program memory 274. In addition to or as an alternative to fetching instructions from the local program memory 274, the program counter 293 may be configured to support the hierarchical addressing of the wider architecture, generating addresses to locations that are external to the processing element 170 in the memory hierarchy, such as a global address that results in one or more read requests being issued to a cluster memory 162, to a program memory 274 within a different processing element 170, to a main memory (not illustrated, but connected to memory controller 114 in FIG. 1), to a location in a memory on another processor chip 100 (e.g., via a serial bus 112), etc. The micro-sequencer 291 also controls the timing of the instruction pipeline 292.

The program counter 293 may present the address of the next instruction in the program memory 274 to enter the instruction execution pipeline 292 for execution, with the instruction fetched 320 by the micro-sequencer 291 in accordance with the presented address. The microsequencer 291 utilizes the instruction registers 282 for instructions being processed by the instruction execution pipeline 292. After the instruction is read on the next clock cycle of the clock, the program counter may be incremented (322). A decode stage of the instruction execution pipeline 292 may decode (330) the next instruction to be executed, and instruction registers 282 may be used to store the decoded instructions. The same logic that implements the decode stage may also present the address(es) of the operand registers 284 of any source operands to be fetched to an operand fetch stage.

An operand instruction may require zero, one, or more source operands. The source operands may be fetched (340) from the operand registers 284 by the operand fetch stage of the instruction execution pipeline 292 and presented to an arithmetic logic unit (ALU) 294 of the processor core 290 on the next clock cycle. The arithmetic logic unit (ALU) may be configured to execute arithmetic and logic operations using the source operands. The processor core 290 may also include additional component for execution of operations, such as a floating point unit (FPU) 296. Complex arithmetic operations may also be sent to and performed by a component or components shared among processing elements 170a-170h of a cluster via a dedicated high-speed bus, such as a shared component for executing floating-point divides (not illustrated).

An instruction execution stage of the instruction execution pipeline 292 may cause the ALU 294 (and/or the FPU 296, etc.) to execute (350) the decoded instruction. Execution by the ALU 294 may require a single cycle of the clock, with extended instructions requiring two or more cycles. Instructions may be dispatched to the FPU 296 and/or shared component(s) for complex arithmetic operations in a single clock cycle, although several cycles may be required for execution.

If an operand write (360) will occur to store a result of an executed operation, an address of a register in the operand registers 284 may be set by an operand write stage of the execution pipeline 292 contemporaneous with execution. After execution, the result may be received by an operand write stage of the instruction pipeline 292 for write-back to one or more registers 284. The result may be provided to an operand write-back unit 298 of the processor core 290, which performs the write-back (362), storing the data in the operand register(s) 284. Depending upon the size of the resulting operand and the size of the registers, extended operands that are longer than a single register may require more than one clock cycle to write.

Register forwarding may also be used to forward an operand result back into the execution stage of a next or subsequent instruction in the instruction pipeline 292, to be used as a source operand execution of that instruction. For example, a compare circuit may compare the register source address of a next instruction with the register result destination address of the preceding instruction, and if they match, the execution result operand may be forwarded between pipeline stages to be used as the source operand for execution of the next instruction, such that the execution of the next instructions does not need to fetch the operand from the registers 284.

To preserve data coherency, a portion of the operand registers 284 being actively used as working registers by the instruction pipeline 292 may be protected as read-only by the data transaction interface 272, blocking or delaying write transactions that originate from outside the processing element 170 which are directed to the protected registers. Such a protective measure prevents the registers actively being written to by the instruction pipeline 292 from being overwritten mid-execution, while still permitting external components/processing elements to read the current state of the data in those protected registers.

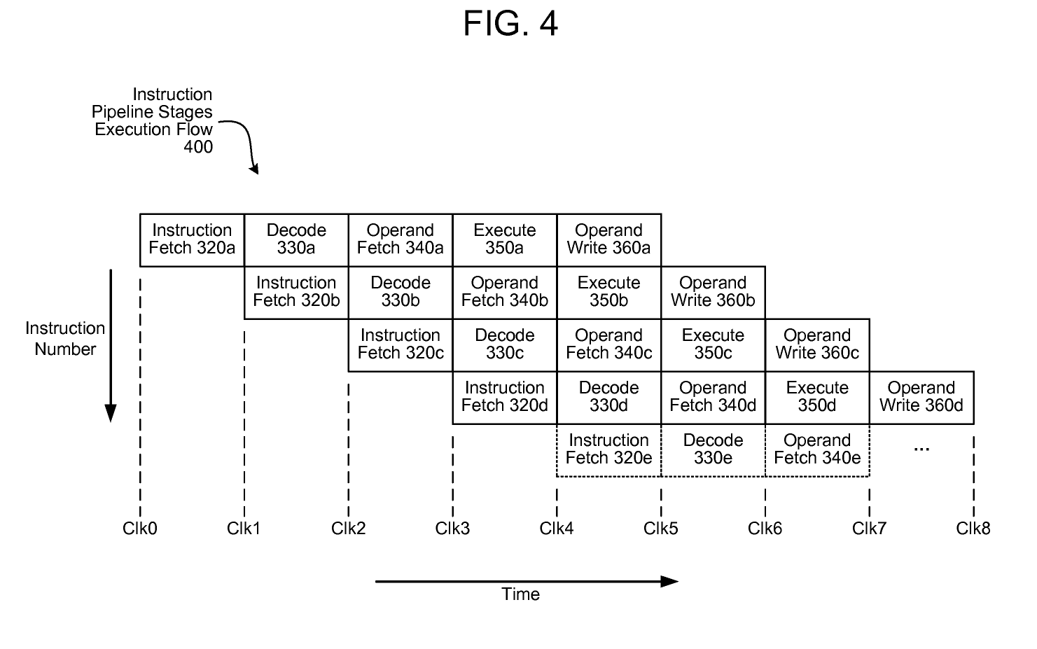

FIG. 4 illustrates an example execution process flow 400 of the micro-sequencer/instruction pipeline stages in accordance with processes in FIG. 3. As noted in the discussion of FIG. 3, each stage of the pipeline flow may take as little as one cycle of the clock used to control timing. Although the illustrated pipeline flow is scalar, a processor core 290 may implement superscalar parallelism, such as a parallel pipeline where two instructions are fetched and processed on each clock cycle.

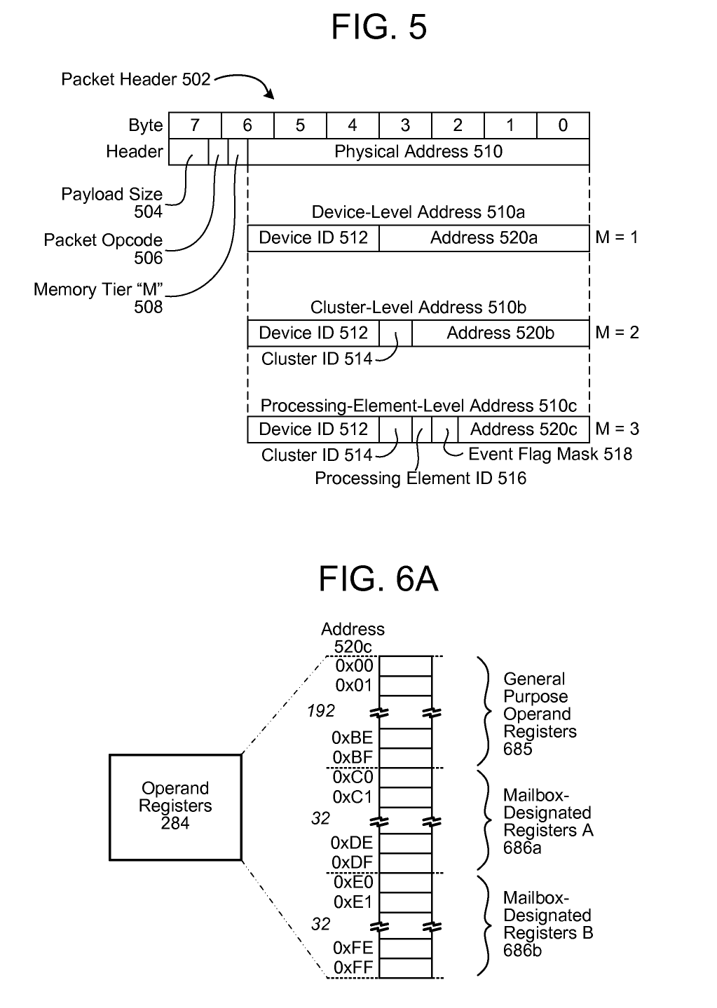

FIG. 5 illustrates an example of a packet header 502 used to support inter-element register communication using global addressing. A processor core 170 may access its own operand registers 284 directly without a global address or use of packets. For example, if each processor core has 256 operand registers 284, the core 290 may access each register via the register's 8-bit unique identifier. In comparison, a global address may be (for example) 64 bits. Similarly, if each processor core has its own program memory 274, that program memory 274 may also be accessed by the associated core 290 using a specific addresses' local identifier without use of a global address or packets. In comparison, shared memory and the accessible locations in the memory and registers of other processing elements may be addressed using a global address of the location, which may include that address' local identifier and the identifier of the tier (e.g., device ID 512, cluster ID 514).

For example, as illustrated in FIG. 5, a packet header 502 may include a global address. A payload size 504 may indicate a size of the payload associated with the header. If no payload is included, the payload size 504 may be zero. A packet opcode 506 may indicate the type of transaction conveyed by the header 502, such as indicating a write instruction or a read instruction. A memory tier “M” 508 may indicate what tier of device memory is being addressed, such as main memory (connected to memory controller 114), cluster memory 162, or a program memory 274, hardware registers 276, or execution registers 280 within a processing element 170.

The structure of the physical address 510 in the packet header 502 may vary based on the tier of memory being addressed. For example, at a top tier (e.g., M=1), a device-level address 510a may include a unique device identifier 512 identifying the processor chip 100 and an address 520a corresponding to a location in main-memory. At a next tier (e.g., M=2), a cluster-level address 510b may include the device identifier 512, a cluster identifier 514 (identifying both the supercluster 130 and cluster 150), and an address 520b corresponding to a location in cluster memory 162. At the processing element level (e.g., M=3), a processing-element-level address 510c may include the device identifier 512, the cluster identifier 514, a processing element identifier 516, an event flag mask 518, and an address 520c of the specific location in the processing element's operand registers 284, program memory 274, etc.

The event flag mask 518 may be used by a packet to set an “event” flag upon arrival at its destination. Special purpose registers 286 within the execution registers 280 of each processing element may include one or more event flag registers 288, which may be used to indicate when specific data transactions have occurred. So, for example, a packet header designating an operand register 284 of another processing element 170 may indicate to set an event flag upon arrival at the destination processing element. A single event flag but may be associated with all the registers, or with a group of registers. Each processing element 170 may have multiple event flag bits that may be altered in such a manner. Which flag is triggered may be configured by software, with the flag to be triggered designated within the arriving packet. A packet may also write to an operand register 284 without setting an event flag, if the packet event flag mask 518 does not indicate to change an event flag bit.

The event flags may provide the micro-sequencer 291/instruction pipeline 292 circuitry—and op-code instructions executed therein—a means by which a determination can be made as to whether a new operand has been written or read from the operand registers 284. Whether an event flag should or should not be set may depend, for example, on whether an operand is time-sensitive. If a packet header 502 designates an address associated with a processor core's program memory 274, a cluster memory 162, or other higher tiers of memory, then a packet header 502 event flag mask 518 indicating to set an event flag may have no impact, as other levels of memory are not ordinarily associated with the same time sensitivity as execution registers 280.

An event flag may also be associated with an increment or decrement counter. A processing element's counters (not illustrated) may increment or decrement bits in the special purpose registers 286 to track certain events and trigger actions. For example, when a processor core 290 is waiting for five operands to be written to operand registers 284, a counter may be set to keep track of how many times data is written to the operand registers 284, triggering an event flag or other “event” after the fifth operand is written. When the specified count is reached, a circuit coupled to the special purpose register 286 may trigger the event flag, may alter the state of a state machine, etc. A processor core 290 may, for example, set a counter and enter a reduced-power sleep state, waiting until the counter reaches the designated value before resuming normal-power operations (e.g., declocking the microsequencer 291 until the counter is decremented to zero).

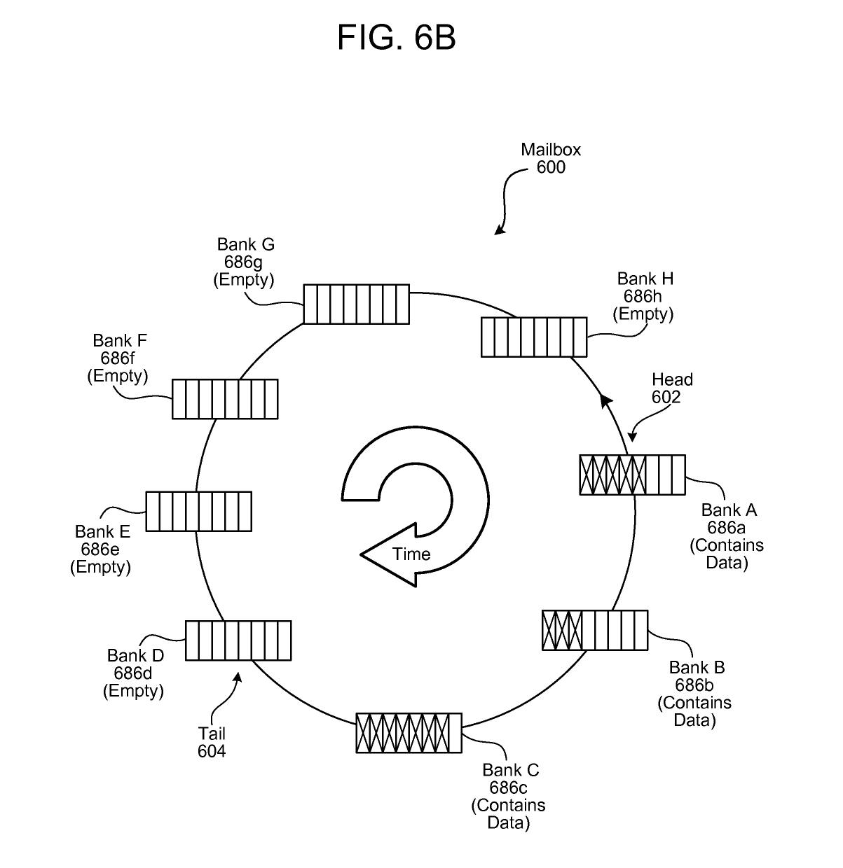

One problem that can arise is if multiple processing elements 170 attempt to write to a same register address. In that case, a stored operand may be overwritten by a remote processor core before it is acted upon by the processor core associated with the register. To prevent this, as illustrated in FIG. 6A, each processor core 290 may configure blocks of operand registers 686 to serve as banks of a circular queue that serves as the processor core's “mailbox.” A mailbox enable flag (e.g., a flag within the special purpose registers 286) may be used to enable and disable the mailbox. When the mailbox is disabled, the block of registers 686 function as ordinary operand register 284 (e.g., the same as general purpose operand registers 685).

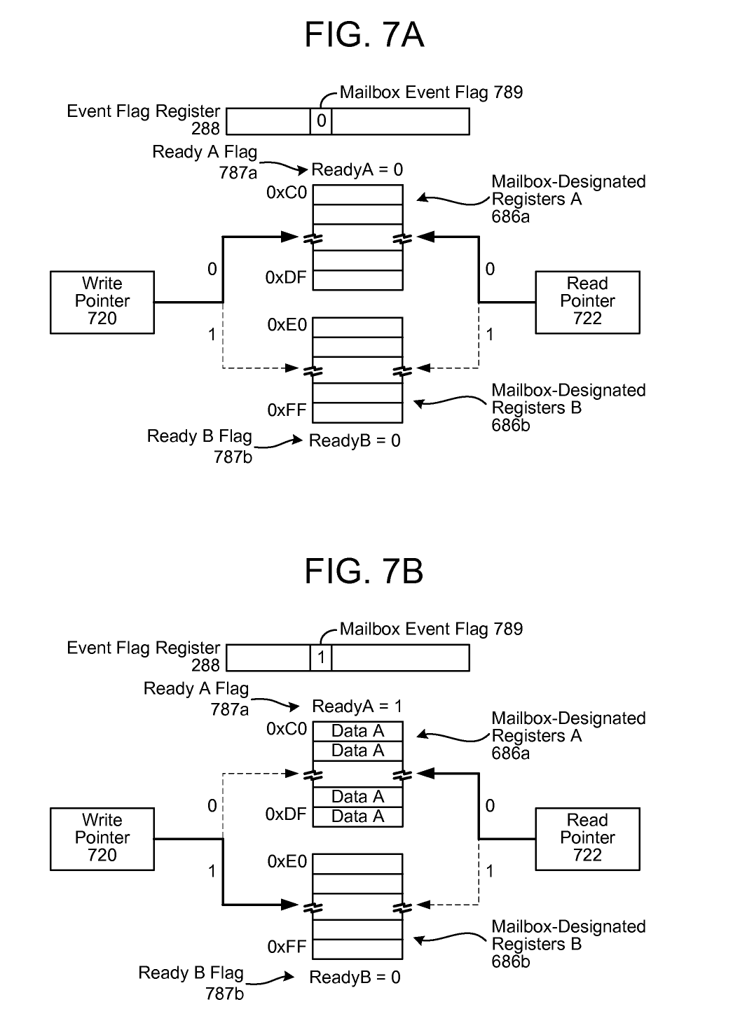

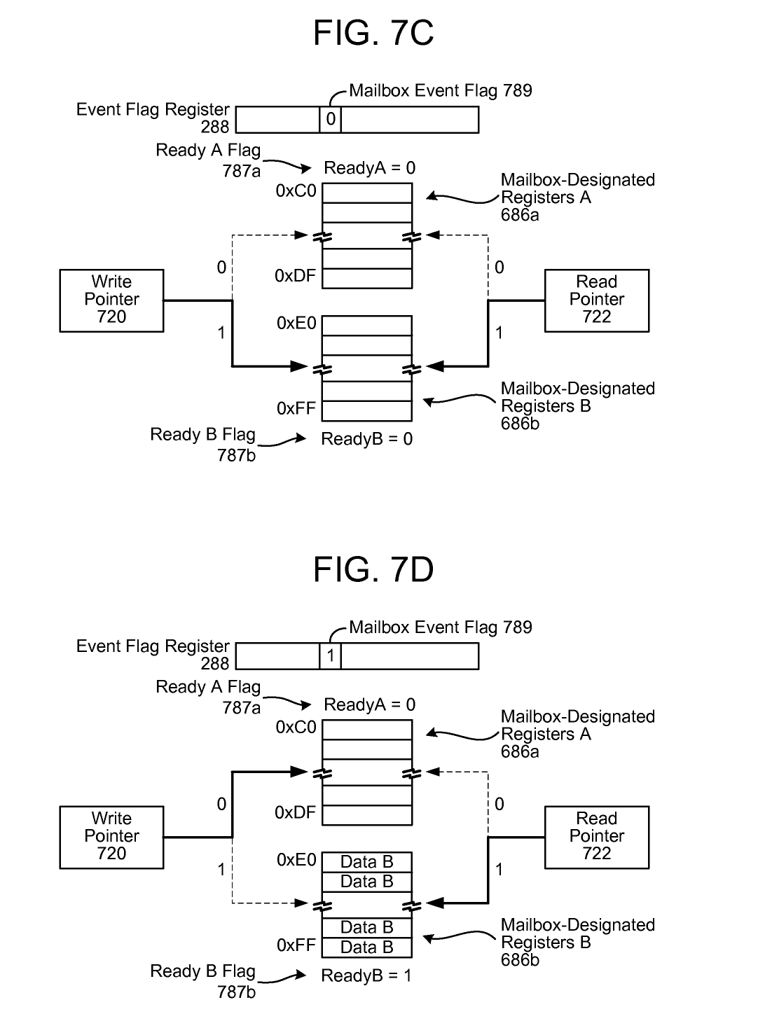

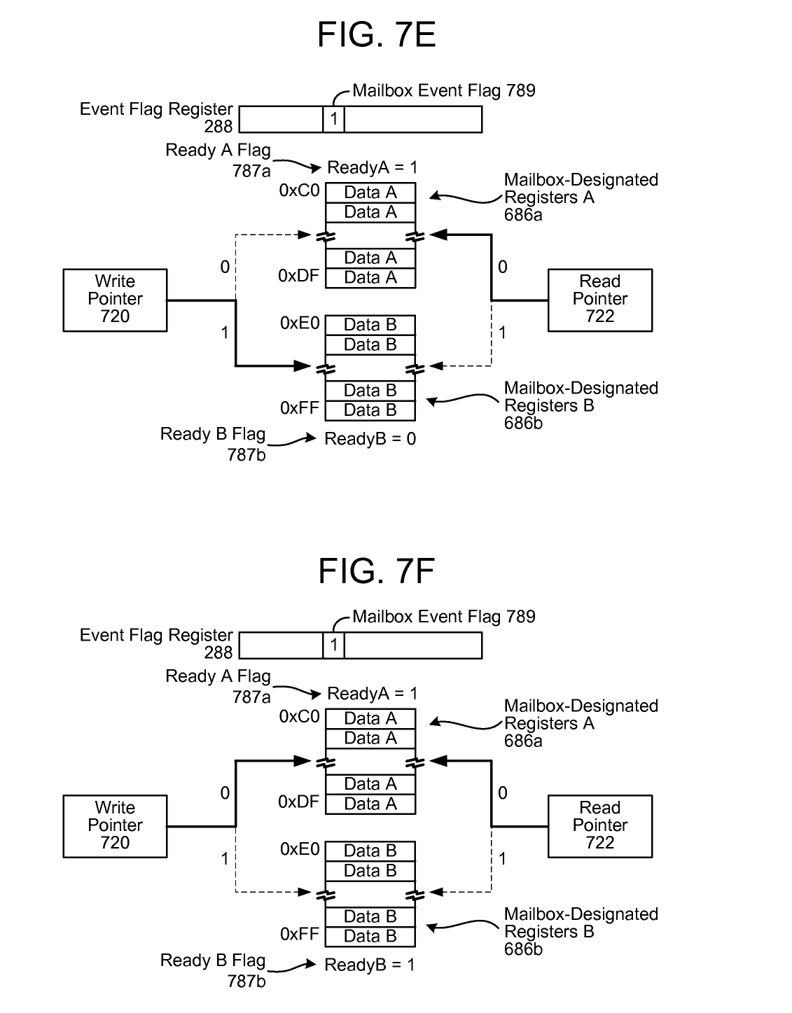

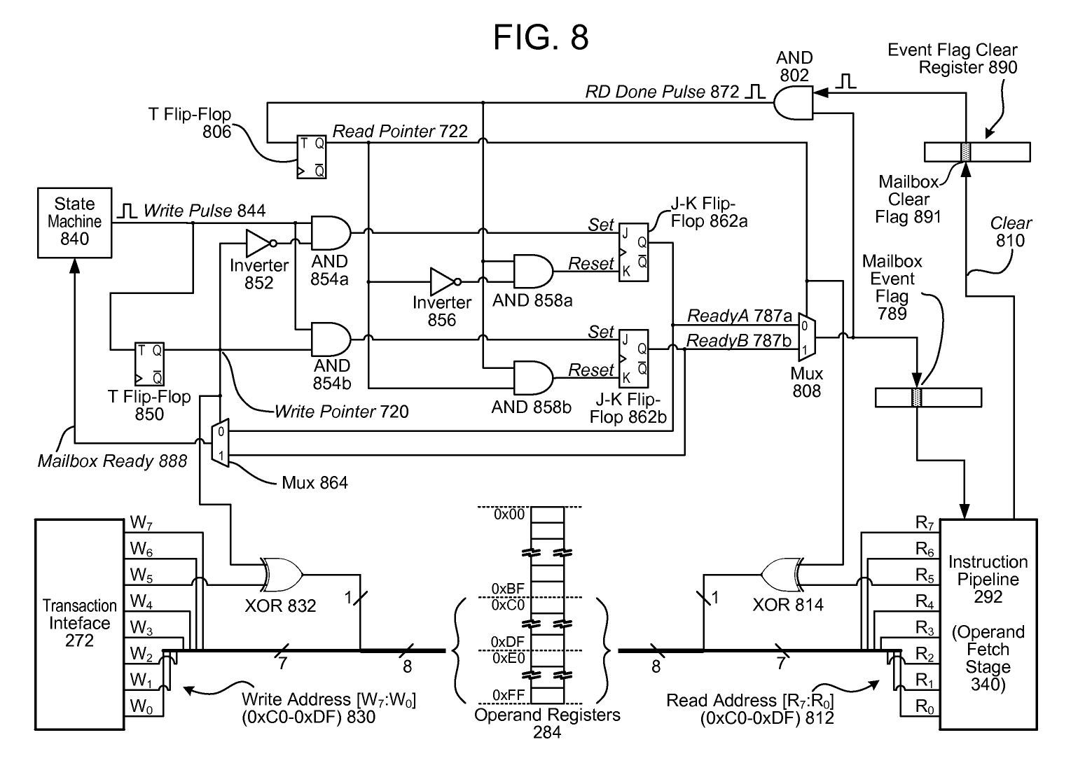

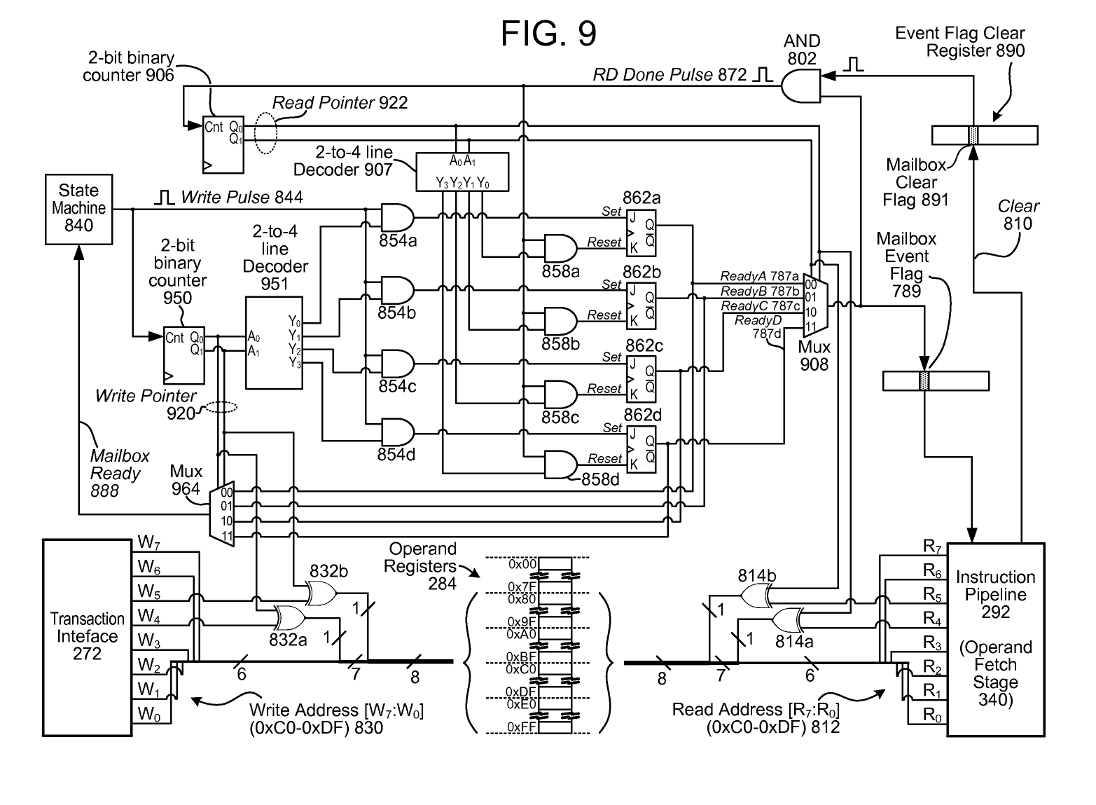

When the mailbox is enabled, the processing element 170 can determine whether there is data available in the mailbox based on a mailbox event flag register (e.g., 789 in FIGS. 7A to 9). After the processing element 170 has read the data, it will signal that the bank of registers (e.g., 686a, 686b) in the mailbox has been read and is ready to be reused to store new data by setting a mailbox clear flag (e.g., 891 in FIGS. 8 and 9). After being cleared, the bank of registers may be used to receive more mailbox data. If no mailbox bank of registers is clear, data may back up in the system until an active bank becomes available. A processing element 170 may go into a “sleep” state to reduce power consumption while it waits for delivery of an operand from another processing element, waking up when an operand is delivered to its mailbox (e.g., declocking the microsequencer 291 while it waits, and reclocking the microsequencer 291 when the mailbox event flag indicates data is available).

As noted above, each operand register 284 may be associated with a global address. General purpose operand registers 685 may each be individually addressable for read and write transactions using that register's global address. In comparison, transactions by external processing elements to the registers 686 forming the mailbox queue may be limited to write-only transactions. Also, when arranged as a mailbox queue, write transactions to any of the global addresses associated with the registers 686 forming the queue may be redirected to the tail of the queue.

FIG. 6B is an abstract representation of how the mailbox banks are accessed for reads and write in a circular fashion. Each mailbox 600 may comprise a plurality of banks of registers (e.g., banks 686a to 686h), where the banks operate as a circular queue. In the circular queue, the “tail” (604) refers to the a next active bank of the mailbox that is ready to receive data, into which new data may be written (686d as illustrated in FIG. 6B) via the data transaction interface 272, as compared to the “head” (602) from which data is next to be read by the instruction pipeline 292 (686a as illustrated in FIG. 6B). After data is read from a bank at the head 602 of the queue by the instruction pipeline 292 and the bank is cleared (or ready to be cleared/overwritten), that bank circles back around the circular mailbox queue until it reaches the tail 604 and is written to again by the transaction interface 272.

As illustrated in FIG. 6B, the register banks containing data (686a, 686b, 686c) each contain different amounts of data (filled registers are represented with an “X”, whereas no “X” appears in empty registers). This is to illustrate that the size of the data payloads of the packets written to the mailbox may be different, with some packets containing large payloads, while other contain small payloads. The size of each bank 686a-686h may be equal to a largest payload that a packet can carry (in accordance with the packet communication protocol). In the alternative, bank size may be independent of the largest payload, and if a packet contains a payload that is too large for a single bank, plural banks may be filled in order until the payload has been transferred into the mailbox. Also, although each bank in FIG. 6B is illustrated as having eight registers per bank, the banks are not so limited. For example, each bank may have sixteen registers, thirty-two registers, sixty-four registers, etc.

The mailbox event flag may indicate when data is written into a bank of the mailbox 600. Unlike the event flags set by packet event-flag-mask 518, the mailbox event flag (e.g., 789 in FIGS. 7A to 9) may be set when the bank pointed to by the head 602 contains data (i.e., when the register bank 686a-686h specified by the read pointer 722/922 in FIGS. 7A to 9 contains data). For example, at the beginning of execution, the head 602 and tail 604 point to empty Bank A (686a). After the writing of data into Bank A is completed, the mailbox event flag is set. After the mailbox event flag is cleared by the processor core 290, the head 602 points to Bank B (686b). The tail 604 may or may not be pointing to Bank B, depending on the number of packets that have arrived. If Bank B has data, the mailbox event flag is set again. If Bank B does not have data, the mailbox event flag is not set until the writing of data into Bank B is completed.

When a remote processing element attempts to write an operand into a register that is blocked (e.g., due to the local processor core 290 executing an instruction that is currently using that register), the write operation may instead be deposited into the mailbox 600. An address pointer associated with the mailbox 600 may redirect the incoming data to a register or registers within the address range of the next active bank corresponding to the current tail 604 of the mailbox (e.g., 686d in FIG. 6B). If the mailbox 600 is turned on and an external processor attempts to directly write to an intermediate address associated with a register included in the mailbox 600, but which is not at the tail 604 of the circular queue, the mailbox's write address pointer may redirect the write to the next active bank at the tail 604, such that attempting an external write to intermediate addresses in the mailbox 600 is effectively the same as writing to a global address assigned to the current tail 604 of the mailbox.

By flipping an enable/disable bit in a configuration register, the local processor core may selectively enable and disable the mailbox 600. When the mailbox is disabled, the allocated registers 686 may revert back into being general-purpose operand registers 685. The mailbox configuration register may be, for example, a special purpose register 286.

The mailbox may provide buffering as a remote processing element transfers data using multiple packets. An example would be a processor core that has a mailbox where each bank 686 is allocated 64 registers. Each register may hold a “word.” A “word” is a fixed-sized piece of data, such as a quantity of data handled as a unit by the instruction set and/or the processor core 290. However, the payload of each packet may be limited, such as limited to 32 words. If operations necessitate using all 64 registers to transfer operands, then after a remote processor loads the first 32 registers of a first bank via a first packet, a second packet is sent with the next 32 words. The processor core can access the first 32 words in the first bank as the remote processor loads the next 32 words into a next bank.

For example, executed software instructions can read the first 32 words from the first bank, write (copy/move) the first 32 words into a first series of general purpose operand registers 685, read the second 32 words from the second bank, write (copy/move) the second 32 words into a second series of general purpose operand registers 685 so that the first and second 32 words form are arranged (for addressing purposes) in a contiguous series of 64 general purpose registers, with the eventual processing of the received data acting on the contiguous data in the general purpose operand registers 685. This arrangement can be scaled as needed, such as using four banks of 64 registers each to receive 128 words, received as 32 word payloads of four packets.

In addition to copying received words as they reach the head 602 of the mailbox, a counter (e.g., a decrement counter) may be set to determine when an entirety of the awaited data has been loaded into the mailbox 600 (e.g., decremented each time one of the four packets is received until it reaches zero, indicating that an entirety of the 128 words is waiting in the mailbox to be read). Then, after all of the data has been loaded into the mailbox, the data may be copied/moved by software operation into a series of general purpose operand registers 685 from which it will be processed.

A processing element 170 may support multiple mailboxes 600 at a same time. For example, a first remote processing element may be instructed to write to a first mailbox, a second remote processing element may be instructed to write to a second mailbox, etc. Each mailbox has its own register flags, head (602) address from which it is read, and tail (604) address to which it is written. In this way, when data is written into a mailbox 600, the association between pipeline instructions and received data is clear, since it simply depends upon the mailbox event flag and address of the head 602 of each mailbox.

Since the mailbox 600 is configured as a circular queue, although the processor core can read registers of the queue individually, the processor does not need to know where the 32 words were loaded and can instead read from the address(s) associated with the head 602 of the queue. For example, after the instruction pipeline 292 reads a first 32 operands from a first bank registers at the head 602 of the mailbox queue and indicates that the first bank of registers can be cleared, an address pointer will change the location of the head 602 to the next bank of registers containing a next 32 operands, such that the processor can access the loaded operands without knowing the addresses of the specific mailbox registers to which the operands were written, but rather, use the address(es) associated with the head 602 of the mailbox.

For example, in a two-bank mailbox queue, a pointer consisting of a single bit can be used as a read pointer to redirect addresses between banks to whichever bank is currently at the head 602 in an alternating high-low fashion. Likewise, a single bit can be used as a write pointer to redirect addresses between banks to whichever bank is currently the tail 604. If half the queue (e.g., 32 words) is designated Bank “A” and the other half is designated Bank “B,” when the first packet arrives (e.g., 32 words), it may be written to “A.” When the next packet (e.g., another 32 words) arrives, it may be written to “B.” Once the instruction pipeline indicates it is done reading “A,” then the next 32 words may be written to “A.” And so on. This arrangement is scalable for mailboxes including more register banks simply by using more bits for the read and write pointers (e.g., 2 bits for the read pointer and 2 bits for the write pointer for a mailbox with four banks, 3 bits each for a mailbox with eight banks, 4 bits each for a mailbox with sixteen banks, etc.).

By default, when a processor core is powered on, a write pointer may point to one of the banks of registers of the mailbox queue 600. After data is written to a first bank, the write pointer may switch to the second bank. When every bank of a mailbox 600 contains data, a flag may be set indicating that the processor core is unable to accept mailbox writes, which may back up operations throughout the system.

For example, in a two-bank mailbox where both banks are full, after the processor core 290 is done reading operands from one of the two banks of mailbox registers, the processor core may clear the mailbox flag, allowing new operands to be written to the mailbox, with the write pointer switching between Bank A and Bank B based on which bank has been cleared.

While switching between banks may be performed automatically, the clearing of the mailbox flag may be performed by the associated operand fetch or instruction execution stages of the instruction pipeline 292, such that instructions executed by the processor core have control over whether to release a bank at the head 602 of the mailbox for receiving new data. So, for example, if program execution includes a series of instructions that process operands in the current bank at the head 602, the last instruction (or a release instruction) may designate when operations are done, allowing the bank to be released and overwritten. This may minimize the need to move data out of the operational registers, since both the input and output operands may use the same registers for execution of multiple operations, with the final result moved to a register elsewhere or a memory location before the mailbox bank at the head 602 is released to be recycled.

The general purpose operand registers 685 can be both read and written via packet, and by instructions executed by the associated processor core 290 of the processing element 170 addressing the operand registers 685. For access by packet, the packet opcode 506 may be used to determine the access type. The timing of packet-based access of an operand register 685 may be independent from the timing of the execution of opcode instruction execution by the associated processor core 290 utilizing that the same operand register. Packet-based writes may have higher priority to the general purpose operand registers 685, and as such may not be blocked.

Referring back to FIG. 6A, the mailbox registers are divided into two banks: Bank A mailbox-designated registers 686a and Bank B mailbox-designated registers 686b. The operand registers 284 may be divided into more than two banks, but to simplify explanation, a two-bank mailbox example will first be discussed.

The mailbox address ranges used as the head 602 and the tail 604 may be that of the first bank “A” 686a, corresponding in FIG. 6A to hexadecimal addresses 0xC0 through 0xDF. Mailbox registers may be written via packet to the tail 604, but may not be readable via packet. Mailbox registers can be read from the head 602 via instruction executed by the processor core 290. Since all packets directed to the mailbox are presumed to be writes, the packet opcode 506 may be ignored. Packet writes to the mailbox may only be allowed if a mailbox buffer is empty or has been released by the instruction pipeline 292 for recycling. If both banks of registers contain data, packet writes to the mailbox queue may be blocked by the transaction interface 272.

As illustrated in FIG. 6A, an example of a two-bank mailbox queue is implemented using the 64 registers located at operand register hexidecimal addresses 0xC0-0xFF. These 64 registers are broken into two 32-register banks 686a and 686b to produce a double-buffered implementation. The addresses of the head 602 and the tail 604 of the mailbox queue are fixed at addresses 0xC0-0xDF (192-223), with the read pointer directing reads of those addresses to the bank that is currently the head 602, and the write pointer directing writes to those addresses to the bank that is currently the tail 604. Reads of these addresses by the processor core 290 thus behave as “virtual” addresses. This mailbox address range may either physically access registers 0xC0-0xDF in bank “A” 686a, or when the double-buffer is “flipped,” may physically access registers 0xE0-0xFF (224-255) in bank “B” 686b. The registers 686b at addresses 0xE0-0xFF are physical addresses and are not “flipped.”

Data may flow into the mailbox queue from the transaction interface 272 coupled to the Level 4 router 160, and may subsequently be used by the associated instruction pipeline 292. The double-buffered characteristic of a two-bank design may optimize the mailbox queue by allowing the next packet payload to be staged without stalling or overwriting the current data. Increasing the number of banks can increase the amount of data that can be queued, and reduce the risk of stalling writes to the mailbox while the data transaction interface 272 waits for an empty bank to appear at tail 604 to receive data.

FIGS. 7A to 7F illustrate write and read transaction operations on a two-bank mailbox example using the register ranges illustrated in FIG. 6A. A write pointer 720 and a read pointer 722 may indicate which of the two banks 686a/686b is used for that function. If the read pointer 722 is zero (0), then the processor core 290 is reading from Bank A. If read pointer 722 is one (1), then the processor core 290 is reading from Bank B. Likewise, if the write pointer 720 is zero (0), then the transaction interface 272 directs writes to Bank A. If write pointer 720 is one (1), then the transaction interface 272 directs writes to Bank B. These write pointer 720 and read pointer 722 bits control how the mailbox addresses (0xC0-0xDF) are interpreted, redirecting a write address (e.g., 830 in FIG. 8) to the tail 604 and a read address (e.g., 812 in FIG. 8) to the head 602.

Each buffer bank has a “ready” flag (Bank A Ready Flag 787a, Bank B Ready Flag 787b) to indicate whether the respective buffer does or does not contain data. An event flag register 288 includes a mailbox event flag 789. The mailbox event flag 789 serves two purposes. First, valid data is only present in the mailbox when this flag is set. Second, clearing the mailbox event flag 789 will cause the banks to swap.

FIGS. 7A to 7F illustrate a progression of these states. In FIG. 7A, a first state is shown after the mailbox queue has been first activated or is reset. Both read pointer 722 and the write pointer 720 are set to zero. The mailbox banks 686a, 686b are empty, and the mailbox event flag 789 is not asserted. Therefore, the first packet write will fill a register or registers in Bank A 686a, and the processor core 290 will read from Bank A 686b after the mailbox event flag 789 indicates there is valid data is the queue. The mailbox event flag 789 may be the sole means available to the processor core 290 to determine whether there is valid data in the mailbox 600.

In the second step, illustrated in FIG. 7B, after the a packet or packets have been written to Bank A 686a, the ready flag 787a for Bank A 686a indicates that data is available, and the write pointer 720 toggles to point to Bank B 686b indicating the target of the next packet write to the transaction interface 272.

Software instructions executed by the processor core could poll the mailbox event flag 789 to determine when data is available. As an alternative, the micro-sequencer 291 may set an enable register and/or a counter and enter a low-power sleep state until data arrives. The low-power state may include, for example, cutting off a clock signal to the instruction pipeline 292 until the data is available (e.g., declocking the micosequencer 291 until the counter reaches zero or the enable register changes states).

The example sequence continues in FIG. 7C. The processor core 290 finishes using the data in Bank A 686a before another packet arrives with a payload to be written to the mailbox. An instruction executed by the processor core 290 clears the mailbox event flag 789, which causes Bank A 686a to be cleared (or to be ready to be overwritten), changing the ready flag 787a from one to zero. The read pointer 722 also toggles to point at Bank B 686b. At this point, both banks are empty, and both the read pointer 722 and the write pointer 720 are pointing at Bank B.

It is important that the processor core 290 must not clear the mailbox event flag 789 until it is done using the data in the current bank that is at the head 602, or else that data will be lost and the read pointer 722 will toggle.

In FIG. 7D, another packet arrives and is written to Bank B 787b. The arrival of the packet causes the ready flag 787b of Bank B to indicate that data is available, and the write pointer 720 toggles once again to point to empty Bank A 686a. The mailbox event flag 789 is set to indicate to the processor core 290 that there is valid data in the mailbox ready to be read from the head 602. The processor core 290 can now read the valid data from buffer bank B 686b.

The double-buffered behavior allows the next mailbox data to be written to one bank while the processor core 290 is working with data in another bank without requiring the processor core 290 to change its mailbox addressing scheme. In other words, without regard to whether the read pointer 722 is pointing at Bank A 686a or Bank B 686b, the same range of addresses (e.g., 0xC0 to 0xDF) can be used to read the active bank that is currently the head 602. When the instruction pipeline opcode instructions have finished working with the contents of the bank that is current at the head 602, the mailbox can “flip” the read pointer 722 and immediately get the next mailbox data (assuming the next bank has already been written) from the same set of addresses (from the perspective of the processor core 290).

FIG. 7E shows an example of how this would take place. Picking up where FIG. 7B left off, Bank A 686a contains data and the processor core 290 is making use of that data. At this point, another packet comes in, the payload of which is placed in Bank B 686b. As shown in FIG. 7E, Bank B 686b now also contains data.

As illustrated in FIG. 7F, this results in the write pointer 720 being toggled to point to Bank A 686a (which is still in use by the processor core 290). In this case, both banks contain data, and therefore there is no place to put a new packet. Thus, any additional packets may be blocked by the transaction interface 272 and will remain in the inbound router path (e.g., held by the level 4 router 160) until the processor core 290 clears its mailbox event flag 789 flag, which will toggle the read pointer 722 to Bank B 686b, and recycle Bank A 686a so that Bank A can receive the payload of the pending inbound packet. In this state, when the processor core 290 finally does clear the mailbox event flag 789, the read pointer 722 toggles to Bank B 686b which contains data, and the mailbox event flag 789 is instantly set again.

FIG. 8 is a high-level schematic overview illustrating an example of queue circuitry that directs write and read transaction operations between two banks of operand registers as described in FIGS. 7A to 7F. Referring to FIG. 2, the state machine 840 and related logic may be included (among other places) in the data transaction interface 272 or in the processor core 290, although XOR gate 814 would ordinarily be included in the processor core 290.

A mailbox clear flag bit 891 of an event flag register clear register 890 (e.g., another event flag register 288) is tied to an input of an AND gate 802. The mailbox clear flag 891 is set by a clear signal 810 output by the processor core 290 used to clear the mailbox clear register 890. The other input of the AND gate 802 is tied to the output of a multiplexer (“mux”) 808, which switches its output between the Bank A ready flag 787a and the Bank B ready flag 787b, setting the mailbox event flag 789.

When the event flag clear register 890 transitions high (binary “1”) (e.g., indicating that the instruction pipeline 292 is done with the bank at the head 602), and the mailbox event flag 789 is also high (binary “1”), the output of the AND gate 802 transitions high, producing a read done pulse 872 (“RD Done”)). The RD Done pulse 872 is input into a T flip-flop 806. If the T input is high, the T flip-flop changes state (“toggles”) whenever the clock input is strobed. The clock signal line is not illustrated in FIG. 8, but may be input into each flip-flop in the circuit (each clock input illustrated by a small triangle on the flip-flop). If the T input is low, the flip-flop holds the previous value.

The output (“Q”) of the T flip-flop is the read pointer 722 that switches between the mailbox banks, as illustrated in FIGS. 7A to 7F. The read pointer 722 is input as the control signal that switches the mux 808 between the Bank A ready flag bit 787a and the Bank B ready flag bit 787b. When the read pointer 722 is low (binary “0”), the mux 808 outputs the Bank A ready flag 787a. When the read pointer is high, the mux 808 outputs the Bank B ready flag 787b. In addition to being input into the AND gate 802, the output of mux 808 sets the mailbox event flag 789.

The read pointer 722 is also input into an XOR gate 814. The other input into the XOR gate 814 is the sixth bit (R₅ of R₀ to R₇) of the eight-bit mailbox read address 812 output by the operand fetch stage 340 of the instruction pipeline 292. The output of the XOR gate 814 is then substituted back into the read address. The flipping of the sixth bit changes the physical address 812 from a Bank A address to a Bank B address (e.g., hexadecimal C0 becomes E0, and DF becomes FF), such that the read pointer bit 722 controls which bank is read, redirecting the read address 812 to the head 602.

The read pointer 722 is input into an AND gate 858b, and is inverted by an inverter 856 and input into an AND gate 858a. The other input of AND gate 858a is tied to RD Done 872, and the other input of AND gate 858b is also tied to RD Done 872. The output of the AND gate 858a is tied to the “K” input of a J-K flip 862a which functions as a reset for the Bank A ready flag 787a. The “J” input of a JK flip-flop sets the state of the output, and the “K” input acts as a reset. The output of the AND gate 858b is tied to the “K” input of a J-K flip 862b which functions as a reset for the Bank B ready flag 787b. Again, the clock signal line may be connected to the flip-flops, but is not illustrated in FIG. 8.

The Bank A ready flag bit 787a and the Bank B ready flag but 787b are also input into mux 864, which selectively outputs one of these flags based on a state of the write pointer 720. If the write pointer 720 is low, mux 864 outputs the Bank A ready flag bit 787a. If the write pointer is high, mux 864 outputs the Bank B ready flag bit 787b. The output of mux 864 is input into a mailbox queue state machine 840.

After reset of the state machine 840, the write pointer 720 is “0”. Upon packet arrival, the state machine 840 will inspect the mailbox ready flag 888 (output of mux 864). If the mailbox ready flag 888 is “1”, the state machine will wait until it becomes “0.” The mailbox ready flag 888 will become “0” when the read pointer 722 is “0” and the event flag clear register logic generates an RD Done pulse 872. This indicates that the mailbox bank has been read and can now be written by the state machine 840. When the state machine 840 has completed all data writes to the bank it will issue a write pulse 844 which sets the J-K flip-flop 862a and triggers a mailbox event flag 789.

The write pulse 844 is input into an AND gate 854a and an AND gate 854b. The output of the AND gate 854a is tied to the “J” set input of the J-K flip-flop 862a that sets the Bank A ready flag 787a. The output of the AND gate 854b is tied to the “J” set input of the J-K flip-flop 862b that sets the Bank B ready flag 787b. The output of the state machine 840 is also tied to an input “T” of a T flip-flop 850. The output “Q” of the T flip-flop 850 is the write pointer 720. The write pulse 844 will toggle the T flip-flop 850, advancing the write pointer 720, such that the next packet will be written to Bank B as the tail 604.

The write pointer 720, in addition to controlling mux 864, is input into AND gate 854b, and is inverted by inverter 852 and input into AND gate 854a. The write pointer 720 is also connected to an input of an XOR gate 832. The other input of the XOR gate 832 receives sixth bit of the write address 830 (W₅ of W₀ to W₇) received from the transaction interface 272. The output of XOR gate 932 is then recombined with the other bits of the write address to control whether packet payload operands are written to the Bank A registers 686a or the Bank B registers 686b, redirecting the write address 830 to the tail 604. The address may be extracted from the packet header (e.g., by the data transaction interface 272 and/or the state machine 840) and loaded into a counter inside the transaction interface 272. Every time a payload word is written, the counter increments to the next register of the bank that is currently designated as the tail 604.

This design of each processing element 170 permits write operations to both the Bank A registers 686a (addresses 0xC0-0xDF) and the Bank B registers 686b (addresses 0xE0-0xFF). Writes to these two register ranges by the processor core 290 have different results. Writes by the processor core 290 to register address range 0xC0-0xDF (Bank A) will always map to the registers of Bank B 686b addresses in the range 0xE0-0xFF regardless of the value of the mailbox read pointer 722. The processor core 290 is prevented from writing to the registers located at physical address range 0xC0-0xDF to prevent the risk of corruption due to a packet overwrite of the data and/or confusion over the effect of these writes.

Writes by the processor core 290 to the Bank B registers 686b (address range 0xE0-0xFF) will map physically to this range. Writes in this range are treated exactly like writes to the general purpose operand registers 685 in address range 0x00-0xBF, where the write address is always the physical address of the register written. The mailbox two-bank “flipping” behavior has no effect on write accesses to this address range. However, it is advisable to only allow the processor core 290 to write to this range when the mailbox is disabled.

FIG. 9 is another schematic overview illustrating an example of circuitry that directs write and read transaction operations to sets of the operand registers serving as the banks of the mailbox queue. In the example in FIG. 9, the mailbox includes four banks of registers 686a to 686d, but the circuit is readily scalable down to two banks or up in iterations of 2ⁿ banks (n>1).

In FIG. 9, the T flip-flop 806 and inverter 856 of FIG. 8 are replaced by a combination of a 2-bit binary counter 906 and a 2-to-4 line decoder 907. In response to each RD Done pulse 872, the counter 906 increments, outputting a 2-bit read pointer 922. The read pointer 922 is connected to a 4-to-1 mux 908 which selects one of the Bank Ready signals 787a to 787d. The output of the mux 908, like the output of mux 808 in FIG. 8, is tied to an input of the AND gate 802 and sets the mailbox event flag 789.

The read pointer 922 is also connected to XOR gates 814a and 814b. The other inputs to the XOR gates 814a and 814b are the fifth and sixth bits (R₄ and R₅ of R₀ to R₇) of the eight-bit mailbox read address 812 output by the operand fetch stage 340 of the instruction pipeline 292. The output of the XOR gates 814a and 814b are substituted back into the read address, redirecting the read address 812 to the register currently designated as the head 602.

The read pointer 922 is also input into the 2-to-4 line decoder 907. Based on the read pointer value at inputs A₀ to A₁, the decoder 907 sets one of its four outputs high, and the others low. Each output Y₀ to Y₃ of the decoder 907 is tied to one of the AND gates 858a to 858d, each of which is tied to the “K” reset input of a respective J-K flip-flop 862a to 862d. As in FIG. 8, the J-K flip-flops 862a to 862d output the Bank Ready signals 787a to 787d.

The T flip-flop 850 and the inverter 852 are replaced by a combination of a 2-bit binary counter 950 and a 2-to-4 line decoder 951. In response to each write pulse 844, the counter 950 increments, outputting a 2-bit write pointer 920. The write pointer 920 is connected to a 4-to-1 mux 964 which selects one of the Bank Ready signals 787a to 787d. The output of the mux 964, like the output of mux 864 in FIG. 8, is the mailbox ready signal 888 input into the state machine 840.

The write pointer 920 is also connected to XOR gates 832a and 832b. The other inputs to the XOR gates 832a and 832b are the fifth and sixth bits (W₄ and W₅ of W₀ to W₇) of the eight-bit mailbox write address 830 output by the transaction interface 272. The output of the XOR gates 832a and 832b are substituted back into the write address, redirecting the write address 830 to the tail 604.

The write pointer 920 is also input into the 2-to-4 line decoder 951. Based on the write pointer value at inputs A₀ to A₁, the decoder 951 sets one of its four outputs high, and the others low. Each output Y₀ to Y₃ of the decoder 951 is tied to one of the AND gates 854a to 854d, each of which is tied to the “J” set input of a respective J-K flip-flop 862a to 862d.

The binary counters 922 and 950 count in a loop, incrementing based on a transition of the signal input at “Cnt” and resetting when the count exceeds their maximum value. The number of banks to be included in the mailbox may be set by controlling the 2-bit binary counters 906 and 950 to set the range of the read pointer 922 and the write pointer 920. For example, a special purpose register 286 may specify how many bits are to be used for the read pointer 922 and the write pointer 920 (not illustrated), setting the number of banks in the mailbox 600 from 2 to 2ⁿ (e.g, in FIG. 9, n=2 since there are four parallel bank-ready circuits).

An upper limit on the read and write pointers can be set by detecting a “roll over” value to reset the counters 906/950, reloading the respective counter with zero. For example, to write to only two banks 686 in FIG. 9, either the Q₁ output of 2-bit binary counter 950 or the Y₂ output of the 2-to-4 line decoder 951 may be used to trigger a “roll over” of the write pointer 920. When the write pulse 844 advances the count (as output by counter 950) to “two” (in a sequence zero, one, two), this will cause the Q₁ bit and the Y₂ bit to go high, which can be used to reset the counter 950 to zero. The effective result is that the write pointer 920 alternates between zero and one. To trigger this roll over, simple logic may be used, such as tying one input of an AND gate to the Q₁ output of counter 950 or the Y₂ output of the decoder 951, and the other input of the AND gate to a special purpose register that contains a decoded value corresponding to the count limit. The output of the AND gate going “high” is used to reset the counter 950, such that when the write pointer 920 exceeds the count limit, the AND gate output goes high, and the counter 950 is reset to zero.

Similarly, to read from only two banks, the Q₁ output of the 2-bit binary counter 906 or the Y₂ output of the 2-to-4 line decoder 907 may be used to trigger a “roll over” of the read pointer 922. When the RD Done pulse 872 advances the count (as output by counter 906) to “two” (in a sequence zero, one, two), this will cause the Q₁ bit and the Y₂ bit to go high, which can be used to reset the counter 906 to zero. To trigger the roll over, simple logic may be used, such as tying one input of an AND gate to the Q₁ output of counter 906 or the Y₂ output of the decoder 907, and the other input of the AND gate to the register that contains the decoded value corresponding to the count limit. The same decoded value is used to set the limit on both counters 906 and 950. The output of the AND gate going “high” is used to reset the counter 906, such that when the read pointer 922 exceeds the count limit, the AND gate output goes high, and the counter 906 is reset to zero.

This ability to adaptively set a limit on how many register banks 686 are used is scalable with the circuit in FIG. 9. For example, if the ability to support eight register banks is needed, 3-bit binary counters and 3-to-8 line decoders would be used (replacing 906, 907, 950, and 951), there would be eight sets of AND gates 854/854 and J-K flip-flops 862, the muxes 908 and 964 would be eight-to-one, and a third pair of XOR gates 814/832 would be added for address translation. To support sixteen register banks, 4-bit binary counters and 4-to-16 line decoders would be used, there would be sixteen sets of AND gates 854/854 and J-K flip-flops 862, the muxes 908 and 964 would be sixteen-to-one, and a third and fourth pair of XOR gates 814/832 would be added for address translation.

To reset the counters in a scaled-up version of the circuit, multiple AND gates would be used to adaptively configure the circuit to support different count limits. For example, if the circuit is configured to support up to sixteen register banks, a first AND gate would have an input tied to the Q₁ output of the counter or Y₂ output of the decoder, a second AND gate would have an input tied to the Q₂ output of the counter or Y₄ output of the decoder, and a third AND gate would have an input tied to the Q₃ output of the counter or the Y₈ output of the decoder. The other input of each of the first, second, and third AND gates would be tied to a different bit of the register that contains the decoded value corresponding to the count limit.

The outputs of the first, second, and third AND gates would be input into a 3-input OR gate, with the output of the OR gate being used to reset the counter (when any of the AND gate outputs goes “high,” the output of the OR gate would go “high”). So for instance, if only two banks are to be used, the count limit is set so that the counter will roll over when the count reaches “two” (in a sequence zero, one, two). If only four banks are to be used, the count limit is set so that the counter will roll over when the count reaches “four” (in a sequence zero, one, two, three, four). If only eight banks are to be used, the count limit is set so that the counter will roll over when the count reaches “eight.” To use all sixteen banks, the decoded value corresponding to the count limit is set to all zeros, such that the counter will reset when it reaches its maximum count limit, with the pointers 920/922 counting from zero to fifteen before looping back to zero. The described logic circuit would be duplicated read and write count circuitry, with both read and write using the same count limit. In this way, the number of banks used within a mailbox may be adaptively set.

An example of how direct register operations may be used would be when a processor core 290 is working on a process and distributes a computation operation to another processing element 170. The processor core 290 may send the other processor a packet indicating the operation, the seed operands, a return address corresponding to its own operand register or registers, and an indication as to whether to trigger a flag when writing the resulting operand (and possibly which flag to trigger).

The clock signals used by different processing elements 170 of the processor chip 100 may be different from each other. For example, different clusters 150 may be independently clocked. As another example, each processing element may have its own independent clock.

The direct-to-register data-transfer approach may be faster and more efficient than direct memory access (DMA), where a general-purpose memory utilized by a processing element 170 is written to by a remote processor. Among other differences, DMA schemes may require writing to a memory, and then having the destination processor load operands from memory into operational registers in order to execute instructions using the operands. This transfer between memory and operand registers requires both time and electrical power. Also, a cache is commonly used with general memory to accelerate data transfers. When an external processor performs a DMA write to another processor's memory, but the local processor's cache still contains older data, cache coherency issues may arise. By sending operands directly to the operational registers, such coherency issues may be avoided.

A compiler or assembler for the processor chip 100 may require no special instructions or functions to facilitate the data transmission by a processing element to another processing element's operand registers 284. A normal assignment to a seemingly normal variable may actually transmit data to a target processing element based simply upon the address assigned to the variable.

Optionally, the processor chip 100 may include a number of high-level operand registers dedicated primarily or exclusively to the purpose of such inter-processing element communication. These registers may be divided into a number of sections to effectively create a queue of data incoming to the target processor chip 100, into a supercluster 130, or into a cluster 160. Such registers may be, for example, integrated into the various routers 110, 120, 140, and 160. Since they may be intended to be used as a queue, these registers may be available to other processing elements only for writing, and to the target processing element only for reading. In addition, one or more event flag registers may be associated with these operand registers, to alert the target processor when data has been written to those registers.

As a further option, the processor chip 100 may provide special instructions for efficiently transmitting data to mailbox. Since each processing element may contain only a small number of mailbox registers, each can be addressed with a smaller address field than would be necessary when addressing main memory (and there may be no address field at all if only one such mailbox is provided in each processing element).

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, microprocessor design, and network architectures should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

As used in this disclosure, the term “a” or “one” may include one or more items unless specifically stated otherwise. Further, the phrase “based on” is intended to mean “based at least in part on” unless specifically stated otherwise.

What is claimed is:

1. A multiprocessor integrated on a semiconductor chip comprises:
a first processing element associated with a first identifier, the first processing element comprising a first processor core including a first operand register; and
a second processing element associated with a second identifier, the second processing element comprising a second processor core including a second operand register; and
a communication pathway communicably interconnecting the first processing element and the second processing element,
wherein:
the first operand register is associated with a first register address, and is accessible to the second processing element via the communication pathway using the first identifier and the first register address, and
the second operand register is associated with a second register address, and is accessible to the first processing element via the communication pathway using the second identifier and the second register address.

2. The multiprocessor of claim 1, the communication pathway comprising a packet router configured to use a packet format that includes a header to indicate a target address for each packet, wherein:
a first target address of read and write transactions to the first operand register by the second processing element include the first identifier and the first register address, and
a second target address of read and write transactions to the second operand register by the first processing element include the second identifier and the second register address.

3. The multiprocessor of claim 1, the first processing element further comprising a transaction interface that couples the communication pathway to the first operand register,
wherein operand register read transactions via the communication pathway are in a format that specifies a target address of a target register from which data is to be read, and a destination address to which the data is to be written, and
the transaction interface, in response to receiving a first read transaction having a first target address specifying the first operand register of the first processing element and having a first destination address specifying the second operand register of the second processing element, reads the data from the first operand register, and transmits the data to the first destination address via the communication pathway.

4. The multiprocessor of claim 1, where the first processor core further comprises:
an instruction execution pipeline;
a queue comprising a plurality of banks of registers including:
a first bank of registers comprising a plurality of third operand registers associated with a plurality of third register addresses, each third operand register being associated with a third register address; and
a second bank of registers comprising a plurality of fourth operand registers associated with a plurality of fourth register addresses, each fourth operand register being associated with a fourth register address;
an event flag indicator that is set when data is written to the queue to indicate to the instruction execution pipeline that data is available,
a first logic circuit to direct a write transaction, from the second processing element to the queue, to the second bank in response to the first bank containing data to be read by the instruction execution pipeline; and
a second logic circuit to direct reads, by the instruction execution pipeline of the queue, to the second bank in response to the second bank containing data to be read by the instruction execution pipeline, and the data in the first bank having been read and cleared by the instruction execution pipeline,
wherein the queue is accessible to the second processing element for the write transaction via the communication pathway.

5. The multiprocessor of claim 1, the first processor core further comprising:
a plurality of operand registers, the plurality of operand registers including the first operand register;
an instruction execution pipeline configured to decode instructions, fetch operands from the plurality of operand registers in accordance with the decoded instructions, and execute the decoded instructions using the fetched operands;
a microsequencer that provides each instruction for execution by the instruction execution pipeline and controls timing of the instruction execution pipeline based on a clock signal; and
an arithmetic logic unit (ALU) configured to execute arithmetic and logic operations for the instruction execution pipeline using operands stored in the plurality of operand registers in accordance with decoded instructions,
wherein each operand register of the plurality of operand registers has a first port and a second port, the first port being accessible via the communication pathway and the second port being directly accessible to the instruction execution pipeline, and
a latency for the instruction execution pipeline to fetch an operand stored in the plurality of operand registers is no longer than two cycles of the clock signal.

6. The multiprocessor of claim 5, the instruction execution pipeline is configured to decode a first instruction, which as defined in an instruction set, directly encodes that a first source operand is to be fetched from the first operand register, the instruction set permanently mapping the first instruction to the first operand register.

7. A network-on-a-chip processor comprises a plurality of processing elements, each of said processing elements including:
an arithmetic logic unit;
a first plurality of operand registers, each operand register of the first plurality of operand registers having a global address, each global address on the network-on-a-chip processor being different;
an instruction execution pipeline configured to decode instructions, read data directly from the first plurality of operand registers in accordance with the decoded instructions, and execute the decoded instructions using the arithmetic logic unit; and
a microsequencer configured to provide a stream of instructions to the instruction execution pipeline for execution,
wherein processing elements can read and can write to each operand register of the first plurality of operand registers of other processing elements using a read or write to the global address of that operand register.

8. The network-on-a-chip processor of claim 7, further comprising:
a network communicably interconnecting each of the plurality of processing elements, the network being a bus-based network or a packet-based network,
wherein a read or write data by one processing element to the operand register of another processing element is conveyed via the network,
the bus-based network comprising address lines and first data lines, the bus-based network configured to convey the global address of the operand register via the address lines, and convey the data via the first data lines, and
the packet-based network comprising second data lines, the packet-based network configured to convey the global address of the operand register in a packet header and the data in a packet body via the second data lines.

9. The network-on-a-chip processor of claim 7, further comprising:
a network communicably interconnecting each of the plurality of processing elements, the network being a packet-based network,
wherein a read by one processing element of a first operand register of the first plurality of operand registers of another processing element is conveyed via the network by a packet, a first global address of a first operand register being specified in a header of the packet, the packet further comprising a second global address of a location to which data read from the first operand register is to be written.

10. The network-on-a-chip processor of claim 7, each of said processing elements further including:
a queue comprising a plurality of banks of operand registers, the instruction execution pipeline to directly read data from the queue as specified in the stream of instructions;
a first address translation switching circuit that redirects a read by the instruction execution pipeline to a bank of the plurality of banks at a head of the queue that contains first data to be read by the instruction execution pipeline, advancing the head to a next bank of the plurality of banks that contains second data after the instruction execution pipeline indicates that it is done reading the first data; and
a second address translation switching circuit that redirects a write by another processing element to a global address associated with the queue to a bank of the plurality of banks at a tail of the queue that is ready to accept data, corresponding to an empty bank or a bank that the instruction execution pipeline has indicated that it is done reading,
wherein after the instruction execution pipeline reads the data from a bank at the head of the queue and indicates that it is done with the bank, that bank is recycled by the queue to be ready to accept data.

11. The network-on-a-chip processor of claim 10, each of said processing elements further including a flag register including an event flag bit that is set when data is stored in the queue to be read by the instruction pipeline, the event flag bit indicating that data is available in the queue.

12. The network-on-a-chip processor of claim 10, wherein the plurality of banks of operand registers includes 2ⁿ banks, where n is greater than 1.

13. A method in a multiprocessor system, comprising:
writing, by a first processing element via a bus, first data to a first operand register of a second processing element using a first address of the first operand register;
decoding a first instruction by an instruction pipeline of the second processing element;
fetching, by the instruction pipeline, the first data by directly accessing the first operand register; and
executing, by the instruction pipeline, the first instruction using the first data.

14. The method of claim 13, further comprising:
reading, by the first processing element, second data from the first operand register of the second processing element using the first address, comprising:
sending via said bus, by the first processing element, a read specifying the first address, and further comprising a second address of a second operand register of the first processing element to receive the second data stored in the first operand register;
sending via said bus, by the second processing element, a reply specifying the second address and comprising the second data stored in the first operand register; and
storing the second data in the second operand register of the first processing element.

15. The method of claim 13, further comprising:
sending via said bus, by the first processing element, a first write including second data to a second address of a second operand register of the second processing element;
receiving the first write at the second processing element;
storing the second data in the second operand register;
setting a flag bit to indicate to the instruction pipeline that the second data has been stored in the second operand register;
sending via said bus, by the first processing element, a second write including third data to the second address after sending the first write;
receiving the second write at the second processing element;
redirecting the second write to a third address of a third operand register of the second processing element, in response to second operand register containing the second data still to be read by the instruction pipeline;
fetching by the instruction pipeline the second data via the second address after the setting of the flag bit;
executing, by the instruction pipeline, a second instruction using the second data;
indicating by the instruction pipeline that the second data has been read;
redirecting a next fetching via the second address by the instruction pipeline to the third data in the third operand register;
executing, by the instruction pipeline, a third instruction using the third data; and
indicating by the instruction pipeline that the third data has been read.

16. The method of claim 15, further comprising:
sending via said bus, by the first processing element, a third write including fourth data to the second address, after sending the second write;
receiving the third write at the second processing element after the indicating that the second data has been read;
storing the fourth data in the second operand register;
fetching by the instruction pipeline the fourth data via the second address after the indicating that the third data had been read; and
executing, by the instruction pipeline, a fourth instruction using the fourth data.

17. The method of claim 13, wherein the writing of the first data via the bus is in a packet format, the first address being specified in a header of a packet and the first data being a payload of the packet.

18. The method of claim 13, further comprising setting a flag bit in response to the first data being written to the first operand register, wherein said fetching is in response to the setting of the flag bit.

19. The method of claim 13, further comprising:
transmitting, by the second processing element via said bus, a second instruction to the first processing element together with the first address to which a result of the second instruction is to be written; and
executing the second instruction by the first processing element, the result being the writing of the first data into the first operand register of the second processing element.

20. The method of claim 19, wherein the second processing element indicates to the first processing element to set a flag bit of the second processing element when writing the result of the second instruction to the first address, the method further comprising:
cutting off a clock signal that controls a timing of operations of the instruction pipeline, by the second processing element, after transmitting the second instruction to the first processing element;
setting the flag bit of the second processing element by the first processing element to indicate the writing the first data to the first operand register; and
restoring the clock signal, by the second processing element, in response to the setting of the flag bit.
